(19) United States
(12) Patent Application Publication
(10) Pub. No.: US 2026/0299190 A1
(43) Pub. Date: Oct. 1, 2026

(54) OPTICAL FIBER AND OPTICAL FIBER RIBBON

(71) Applicant: SUMITOMO ELECTRIC INDUSTRIES, LTD., Osaka (JP)

(72) Inventors: Miho IKEGAWA, Osaka (JP); Noriaki IWAGUCHI, Osaka (JP); Katsushi HAMAKUBO, Osaka (JP)

(21) Appl. No.: 19/475,809

(22) PCT Filed: Mar. 15, 2024
(86) PCT No.: PCT/JP2024/010302

§ 371 Date: Oct. 16, 2025

(30) Foreign Application Priority Data
Apr. 21, 2023 (JP) 2023-069880

(51) Int. Cl. G02B 6/02; G02B 6/44

(52) U.S. Cl. CPC G02B 6/02395; G02B 6/4403

(57) ABSTRACT

An optical fiber comprising a glass fiber including a core and a cladding, a primary resin layer being in contact with the glass fiber and coating the glass fiber, a secondary resin layer coating the primary resin layer; and a colored resin layer coating the secondary resin layer. The colored resin layer includes a cured product of a resin composition containing a photopolymerizable compound, a photopolymerization initiator, a polydimethylsiloxane compound, and titanium oxide particles. A number of titanium-containing particle(s) having a diameter of 5 μm or more contained in the colored resin layer, is less than 15 per mm in a length direction of the colored resin layer. A content of silicon in a surface of the colored resin layer is 0.9 at % or more and 11 at % or less.

### TECHNICAL FIELD

The present disclosure relates to an optical fiber and an optical fiber ribbon. This application claims priority based on Japanese Patent Application No. 2023-069880 filed on Apr. 21, 2023, and the entire contents of which are incorporated herein by reference.

### BACKGROUND ART

In general, an optical fiber includes a coating resin layer for protecting a glass fiber that is an optical transmission medium. The coating resin layer, for example, includes a primary resin layer and a secondary resin layer. The outermost layer of the coating resin layer is composed of a colored resin layer for identifying the optical fiber (see, for example, Patent Literature 1 and 2).

### CITATION LIST

### Patent Literature

Patent literature 1: WO 2016/017060
Patent literature 2: JP 2002-516377 A

### SUMMARY OF INVENTION

An optical fiber according to one aspect of the present disclosure includes a glass fiber including a core and a cladding, a primary resin layer being in contact with the glass fiber and coating the glass fiber, a secondary resin layer coating the primary resin layer, and a colored resin layer coating the secondary resin layer. The colored resin layer includes a cured product of a resin composition containing a photopolymerizable compound, a photopolymerization initiator, a polydimethylsiloxane compound, and titanium oxide particles. A number of titanium-containing particle(s) having a diameter of 5 μm or more contained in the colored resin layer, is less than 15 per mm in a length direction of the colored resin layer. A content of silicon in a surface of the colored resin layer is 0.9 at % or more and 11 at % or less.

### BRIEF DESCRIPTION OF THE DRAWINGS

FIG. 1 is a schematic cross-sectional view showing an example of an optical fiber.

FIG. 2 is a schematic cross-sectional view showing an example of an optical fiber ribbon.

### DETAILED DESCRIPTION

### Problems to be Solved by Present Disclosure

In recent years, with the increase in the number of cores and the reduction in diameter of optical cables, the diameter of optical fibers used in optical cables has been reduced. As the diameter of the optical fiber is reduced, the thickness of the coating resin layer for protecting the glass fiber is also reduced, and the lateral pressure resistance of the optical fiber may be deteriorated. In addition, when the optical fiber is immersed in hot water, the coating resin layer may be peeled off from the glass fiber, resulting in an increase in transmission loss.

An object of the present disclosure is to provide an optical fiber and an optical fiber ribbon that are excellent in lateral pressure resistance and hot water resistance.

### Advantageous Effects of Present Disclosure

According to the present disclosure, an optical fiber and an optical fiber ribbon that are excellent in lateral pressure resistance and hot water resistance can be provided.

### Description of Embodiments of Present Disclosure

First, the contents of the embodiments of the present disclosure will be listed and described.

(1) An optical fiber according to one aspect of the present disclosure includes a glass fiber including a core and a cladding, a primary resin layer being in contact with the glass fiber and coating the glass fiber, a secondary resin layer coating the primary resin layer, and a colored resin layer coating the secondary resin layer. The colored resin layer includes a cured product of a resin composition containing a photopolymerizable compound, a photopolymerization initiator, a polydimethylsiloxane compound, and titanium oxide particles. A number of titanium-containing particle(s) having a diameter of 5 μm or more contained in the colored resin layer, is less than 15 per mm in a length direction of the colored resin layer. A content of silicon in a surface of the colored resin layer is 0.9 at % or more and 11 at % or less.

Such an optical fiber has excellent lateral pressure resistance and hot water resistance by including the colored resin layer in which the number of titanium-containing particle(s) having a diameter of 5 μm or more is less than 15 per mm in the length direction and the content of silicon in the surface is 0.9 at % or more and 11 at % or less.

(2) In the above (1), from the viewpoint of visibility of the colored resin layer and curability of the resin composition, a content of the titanium oxide particles may be 0.6% by mass or more and 20.0% by mass or less with respect to a total amount of the resin composition.

(3) In the above (1) or (2), from the viewpoint of further improving the lateral pressure resistance and the hot water resistance, the polydimethylsiloxane compound may have at least one organic group selected from the group consisting of a (meth)acryloyl group, an epoxy group, and a polyether group.

(4) In any one of the above (1) to (3), from the viewpoint of the lateral pressure resistance and stability of the resin composition, a content of silicon atoms contained in the polydimethylsiloxane compound may be 6% by mass or more and 40% by mass or less.

(5) In any one of the above (1) to (4), from the viewpoint of reducing the diameter of the optical fiber, the optical fiber may have an outer diameter of 140 μm or more and 255 μm or less.

(6) An optical fiber ribbon according to one aspect of the present disclosure is an optical fiber ribbon in which a plurality of optical fibers according to any one of the above (1) to (5) are arranged in parallel and coated with a resin for a ribbon. Such an optical fiber ribbon has excellent lateral pressure resistance and hot water resistance.

### Details of Embodiments of Present Disclosure

Specific examples of an optical fiber and an optical fiber ribbon according to an embodiment of the present disclosure will be described with reference to the drawings as necessary. The present disclosure is not limited to these examples, but is defined by the scope of the claims, and is intended to include all modifications within the meaning and scope equivalent to the scope of the claims. In the following description, the same elements are denoted by the same reference numerals in the description of the drawings, and redundant description will be omitted. In the present specification, (meth)acrylate means an acrylate or its corresponding methacrylate. The same applies to other similar expressions such as (meth)acryloyl.

### (Optical Fiber)

An optical fiber according to the embodiment includes a glass fiber including a core and a cladding, a primary resin layer being in contact with the glass fiber and coating the glass fiber, a secondary resin layer coating the primary resin layer, and a colored resin layer coating the secondary resin layer. The colored resin layer includes a cured product of a resin composition (hereinafter, also referred to as a “resin composition for colored resin layer”) containing a photopolymerizable compound, a photopolymerization initiator, a polydimethylsiloxane compound, and titanium oxide particles.

The polydimethylsiloxane compound is a compound having, as a repeating unit, a dimethylsiloxane skeleton (—Si(CH₃)₂O—) composed of two methyl groups bonded to a silicon atom and an oxygen atom bonded to the silicon atom in the main chain.

A content of silicon atoms (Si) contained in the polydimethylsiloxane compound may be 6% by mass or more, 8% by mass or more, 10% by mass or more, or 12% by mass or more from the viewpoint of further improving the lateral pressure resistance. The content of Si may be 40% by mass or less, 30% by mass or less, 25% by mass or less, or 21% by mass or less from the viewpoint of improving the stability of the resin composition. The content of Si may be 6% by mass or more and 40% by mass or less, 8% by mass or more and 30% by mass or less, 10% by mass or more and 25% by mass or less, or 12% by mass or more and 21% by mass or less from the viewpoint of the lateral pressure resistance and the stability of the resin composition. The content of Si contained in the polydimethylsiloxane compound can be measured by inductively coupled plasma optical emission spectrometry (ICP-OES) of the polydimethylsiloxane compound.

The polydimethylsiloxane compound may have at least one organic group selected from the group consisting of a (meth)acryloyl group, an epoxy group, and a polyether group from the viewpoint of further improving the lateral pressure resistance and the hot water resistance. That is, the polydimethylsiloxane compound may include at least one selected from the group consisting of a polydimethylsiloxane compound having a (meth)acryloyl group, a polydimethylsiloxane compound having an epoxy group, and a polydimethylsiloxane compound having a polyether group, from the viewpoint of further improving the lateral pressure resistance and the hot water resistance. The polydimethylsiloxane compound may have these organic groups in a side chain or at a terminal. Among these organic groups, from the viewpoint of the lateral pressure resistance and the hot water resistance, a (meth)acryloyl group and an epoxy group are preferable, and a (meth)acryloyl group is more preferable.

The polydimethylsiloxane compound having a (meth)acryloyl group may be copolymerized with a photopolymerizable compound to be described below. The polydimethylsiloxane compound having a (meth)acryloyl group is not included in the photopolymerizable compound described below. The number of (meth)acryloyl groups of the polydimethylsiloxane compound may be 1 or more, or 2 or more, and may be 10 or less, or 8 or less.

The number of epoxy groups of the polydimethylsiloxane compound may be 1 or more, or 2 or more, and may be 10 or less, or 8 or less.

The number of polyether groups of the polydimethylsiloxane compound may be 1 or more, or 2 or more, and may be 10 or less, or 8 or less.

From the viewpoint of the lateral pressure resistance and the hot water resistance, a content of the polydimethylsiloxane compound may be 0.3% by mass or more and 4.5% by mass or less with respect to the total amount of the resin composition. When the content of the polydimethylsiloxane compound is 0.3% by mass or more, dispersibility of the titanium oxide particles contained in the resin composition is easily improved, and thus aggregates having a diameter of 5 μm or more generated due to the titanium oxide particles can be reduced, and accordingly, unevenness of a surface of the colored resin layer to be formed can be reduced to reduce frictional force of the colored resin layer, and thus, the lateral pressure resistance of the optical fiber can be further improved. When the content of the polydimethylsiloxane compound is 4.5% by mass or less, the reduction in the adhesion between the colored resin layer and the secondary resin layer can be reduced, and the hot water resistance can be further improved.

From the viewpoint of further improving the lateral pressure resistance, the content of the polydimethylsiloxane compound may be 0.4% by mass or more, or 0.5% by mass or more, with respect to the total amount of the resin composition, and from the viewpoint of further improving the hot water resistance, the content of the polydimethylsiloxane compound may be 4.0% by mass or less, 3.5% by mass or less, 3.0% by mass or less, or 2.5% by mass or less, with respect to the total amount of the resin composition. From the viewpoint of further improving the lateral pressure resistance and the hot water resistance, the content of the polydimethylsiloxane compound may be 0.4% by mass or more and 4.0% by mass or less, 0.4% by mass or more and 3.5% by mass or less, 0.5% by mass or more and 3.0% by mass or less, or 0.5% by mass or more and 2.5% by mass or less, with respect to the total amount of the resin composition.

The photopolymerizable compound is distinguished from a polydimethylsiloxane compound having a (meth)acryloyl group in that the photopolymerizable compound does not have a dimethylsiloxane skeleton. From the viewpoint of increasing the strength of the colored resin layer, the photopolymerizable compound may include epoxy di(meth)acrylate. As the epoxy di(meth)acrylate, for example, a reaction product of a diglycidyl ether compound having a bisphenol skeleton and a compound having a (meth)acryloyl group such as (meth)acrylic acid can be used.

Examples of the epoxy di(meth)acrylate include a (meth)acrylic acid adduct of bisphenol A-diglycidyl ether, a (meth)acrylic acid adduct of bisphenol AF-diglycidyl ether, and a (meth)acrylic acid adduct of bisphenol F-diglycidyl ether.

From the viewpoint of further increasing the strength of the colored resin layer, the content of the epoxy di(meth)acrylate may be 30 parts by mass or more, 40 parts by mass or more, or 45 parts by mass or more, and may be 70 parts by mass or less, 65 parts by mass or less, or 60 parts by mass or less, with respect to 100 parts by mass of the total amount of the polydimethylsiloxane compound and the photopolymerizable compound. The content of the epoxy di(meth)acrylate may be 30 parts by mass or more and 70 parts by mass or less, 40 parts by mass or more and 65 parts by mass or less, or 45 parts by mass or more and 60 parts by mass or less, with respect to 100 parts by mass of the total amount of the polydimethylsiloxane compound and the photopolymerizable compound. The content of the epoxy di(meth)acrylate may be 30% by mass or more and 70% by mass or less, 40% by mass or more and 65% by mass or less, 45% by mass or more and 60% by mass or less, or 50% by mass or more and 60% by mass or less, with respect to the total amount of the photopolymerizable compound.

The photopolymerizable compound may further include a photopolymerizable compound (hereinafter referred to as a “monomer”) other than the epoxy di(meth)acrylate.

As the monomer, a monofunctional monomer having one polymerizable group or a polyfunctional monomer having two or more polymerizable groups can be used. Two or more types of the monomers may be used by being mixed.

Examples of the monofunctional monomer include (meth)acrylate-based monomers such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxy benzyl acrylate, phenoxy diethyleneglycol acrylate, phenoxy polyethylene glycol acrylate, 4-tert-butylcyclohexanol acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, nonylphenoxypolyethylene glycol (meth)acrylate, and isobornyl (meth)acrylate; carboxy group-containing monomers such as (meth)acrylic acid, a (meth)acrylic acid dimer, carboxyethyl (meth)acrylate, carboxypentyl (meth)acrylate, and ω-carboxy-polycaprolactone (meth)acrylate; heterocycle-containing monomers such as N-(meth)acryloylmorpholine, N-vinylpyrrolidone, N-vinylcaprolactam, N-(meth)acryloylpiperidine, N-(meth)acryloylpyrrolidine, 3-(3-pyridine)propyl (meth)acrylate, and cyclic trimethylolpropane formal acrylate; maleimide-based monomers such as maleimide, N-cyclohexylmaleimide, and N-phenylmaleimide; amide-based monomers such as (meth)acrylamide, N,N-dimethyl (meth)acrylamide, N,N-diethyl (meth)acrylamide, N-hexyl (meth)acrylamide, N-methyl (meth)acrylamide, N-ethyl (meth)acrylamide, N-butyl (meth)acrylamide, N-methylol (meth)acrylamide, and N-methylolpropane (meth)acrylamide; aminoalkyl (meth)acrylate-based monomers such as aminoethyl (meth)acrylate, aminopropyl (meth)acrylate, N,N-dimethylaminoethyl (meth)acrylate, and tert-butylaminoethyl (meth)acrylate; and succinimide-based monomers such as N-(meth)acryloyloxymethylene succinimide, N-(meth)acryloyl-6-oxyhexamethylene succinimide, and N-(meth)acryloyl-8-oxyoctamethylene succinimide.

Examples of the polyfunctional monomer include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, propylene oxide-modified neopentyl glycol di(meth)acrylate, polytetraethylene glycol di(meth)acrylate, hydroxypivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, neopentyl glycol di(meth)acrylate, isopentyldiol di(meth)acrylate, 3-ethyl-1,8-octanediol di(meth)acrylate; trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl]isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl]isocyanurate.

From the viewpoint of adjusting the Young's modulus of the colored resin layer, the photopolymerizable compound may contain a polyfunctional monomer modified with alkylene oxide. The polyfunctional monomer modified with alkylene oxide may have at least one selected from the group consisting of an ethylene oxide (EO) chain and a propylene oxide (PO) chain. The ethylene oxide chain can be expressed as “(EO)n”, and the propylene oxide chain can be expressed as “(PO)n”. n is an integer of 1 or more, may be 2 or more, or 3 or more, and may be 30 or less, 25 or less, or 20 or less.

Examples of the polyfunctional monomer modified with alkylene oxide include alkylene oxide-modified di(meth)acrylate and alkylene oxide-modified tri(meth)acrylate.

Examples of the alkylene oxide-modified di(meth)acrylate include polyethylene glycol di(meth)acrylate, isocyanuric acid ethylene oxide-modified di(meth)acrylate, ethylene oxide-modified bisphenol F di(meth)acrylate, ethylene oxide-modified bisphenol A di(meth)acrylate, polypropylene glycol di(meth)acrylate, propylene oxide-modified bisphenol A di(meth)acrylate, and propylene oxide-modified neopentyl glycol di(meth)acrylate.

Examples of the alkylene oxide-modified tri(meth)acrylate include trimethylol propane tri(meth)acrylate, trimethylol octane tri(meth)acrylate, trimethylol propane polyethoxytri(meth)acrylate, trimethylol propane polypropoxytri(meth)acrylate, trimethylol propane polyethoxypolypropoxytri(meth)acrylate, tris[(meth)acryloyl oxyethyl]isocyanurate, and pentaerythritol tri(meth)acrylate.

The content of the polyfunctional monomer modified with alkylene oxide is not particularly limited, but may be 20% by mass or more and 70% by mass or less, 30% by mass or more and 60% by mass or less, or 40% by mass or more and 50% by mass or less, with respect to the total amount of the photopolymerizable compound.

The photopolymerization initiator can be appropriately selected from known radical photopolymerization initiators for use. Examples of the photopolymerization initiator include 1-hydroxycyclohexyl phenyl ketone (Omnirad 184, manufactured by IGM Resins B.V.), 2,2-dimethoxy-2-phenylacetophenone, 1-(4-isopropylphenyl)-2-hydroxy-2-methylpropane-1-one, bis(2,6-dimethoxybenzoyl)-2,4,4-trimethylpentylphosphine oxide, 2-methyl-1-[4-(methylthio)phenyl]-2-morpholino-propane-1-one (Omnirad 907, manufactured by IGM Resins B.V.), 2,4,6-trimethylbenzoyl diphenylphosphine oxide (Omnirad TPO, manufactured by IGM Resins B.V.), and bis(2,4,6-trimethylbenzoyl)phenylphosphine oxide (Omnirad 819, manufactured by IGM Resins B.V.).

The content of the photopolymerization initiator may be 1 part by mass or more and 10 parts by mass or less, 2 parts by mass or more and 8 parts by mass or less, or 3 parts by mass or more and 7 parts by mass or less, with respect to 100 parts by mass of the total amount of the polydimethylsiloxane compound and the photopolymerizable compound.

From the viewpoint of coloring the resin layer, the resin composition according to the embodiment contains titanium oxide particles. As the titanium oxide particles, surface-treated titanium oxide particles may be used. The surface-treated titanium oxide particles are particles in which titanium oxide is subjected to a surface treatment using an inorganic substance, and have excellent dispersibility in the resin composition. Examples of the titanium oxide include anatase-type titanium oxide, rutile-type titanium oxide, and brookite-type titanium oxide. From the viewpoint of stability, the titanium oxide may be rutile-type titanium oxide.

Examples of the inorganic substance used for the surface treatment include aluminum oxide, silicon dioxide, and zirconium dioxide. By the surface-treated titanium oxide particles including a surface-treated layer containing at least one selected from the group consisting of aluminum oxide, silicon dioxide, and zirconium dioxide, it is possible to further improve the dispersibility. The surface-treated layer may be formed on at least a part of the surface of the titanium oxide, or may be formed on the entire surface of the titanium oxide. The surface-treated layer is formed by the surface treatment of the titanium oxide.

The content of the surface-treated layer in the surface-treated titanium oxide particles may be 1.0% by mass or more, 1.5% by mass or more, or 2.0% by mass or more from the viewpoint of improving the dispersibility, and may be 10.0% by mass or less, 9.0% by mass or less, or 8.0% by mass or less from the viewpoint of increasing a hiding power. The content of the surface-treated layer in the surface-treated titanium oxide particles may be 1.0% by mass or more and 10.0% by mass or less, 1.5% by mass or more and 9.0% by mass or less, or 2.0% by mass or more and 8.0% by mass or less, from the viewpoint of the dispersibility and the hiding power. The content of the surface-treated layer can be calculated by measuring the content of the titanium elements and the elements of the inorganic substance other than titanium contained in the surface-treated titanium oxide particles using inductively coupled mass spectrometry (ICP-MS).

The average primary particle diameter of the surface-treated titanium oxide particles may be 300 nm or less, 295 nm or less, or 290 nm or less from the viewpoint of further improving the lateral pressure resistance. The average primary particle diameter of the surface-treated titanium oxide particles may be 100 nm or more, 150 nm or more, or 200 nm or more, and is preferably 200 nm or more and 300 nm or less from the viewpoint of increasing the hiding power. The average primary particle diameter can be measured by, for example, the image analysis of an electron micrograph, a light scattering method, a BET method, and the like.

The content of the titanium oxide particles may be 0.6% by mass or more, 1.0% by mass or more, 2.0% by mass or more, or 3.0% by mass or more, with respect to the total amount of the resin composition, from the viewpoint of improving visibility of the colored resin layer, and may be 20.0% by mass or less, 15.0% by mass or less, 10.0% by mass or less, or 8.0% by mass or less, from the viewpoint of increasing curability of the resin composition. The content of the titanium oxide particles may be 0.6% by mass or more and 20.0% by mass or less, 1.0% by mass or more and 15.0% by mass or less, 2.0% by mass or more and 10.0% by mass or less, or 3.0% by mass or more and 8.0% by mass or less with respect to the total amount of the resin composition from the viewpoint of the visibility of the colored resin layer and the curability of the resin composition.

The resin composition may further contain a silane coupling agent, a leveling agent, an anti-foaming agent, an antioxidant, a sensitizer, and the like.

The silane coupling agent is not particularly limited as long as it causes no inhibition in curing of the resin composition. Examples of the silane coupling agent include tetramethyl silicate, tetraethyl silicate, mercaptopropyl trimethoxysilane, vinyltrichlorosilane, vinyltriethoxysilane, vinyltris(β-methoxy-ethoxy) silane, β-(3,4-epoxylcyclohexyl)-ethyltrimethoxysilane, dimethoxydimethylsilane, diethoxydimethylsilane, 3-acryloxypropyl trimethoxysilane, γ-glycidoxypropyl trimethoxysilane, γ-glycidoxypropylmethyl diethoxysilane, γ-methacryloxypropyl trimethoxysilane, N-(β-aminoethyl)-γ-aminopropyl trimethoxysilane, N-(β-aminoethyl)-γ-aminopropyltrimethyl dimethoxysilane, N-phenyl-γ-aminopropyl trimethoxysilane, γ-chloropropyl trimethoxysilane, γ-mercaptopropyl trimethoxysilane, γ-aminopropyl trimethoxysilane, bis-[3-(triethoxysilyl)propyl]tetrasulfide, bis-[3-(triethoxysilyl)propyl]disulfide, γ-trimethoxysilylpropyldimethylthiocarbamyltetrasulfide, and γ-trimethoxysilylpropyl benzothiazyl tetrasulfide.

When a breaking elongation of a resin film obtained by curing the resin composition according to the embodiment with an integrated light amount of 900 mJ/cm² or more and 1100 mJ/cm² or less is 6% or more and 50% or less at 23° C., a resin layer having excellent toughness can be formed. The breaking elongation of the resin film may be 6.5% or more, 7% or more, or 10% or more, and may be 45% or less, 40% or less, or 30% or less.

From the viewpoint of the moisture and heat resistance of the optical fiber, the Young's modulus of the resin film may be 400 MPa or more, 450 MPa or more, or 500 MPa or more at 23° C. From the viewpoint of forming a resin layer having excellent toughness, the Young's modulus of the resin film may be 1500 MPa or less, 1200 MPa or less, or 1000 MPa or less at 23° C.

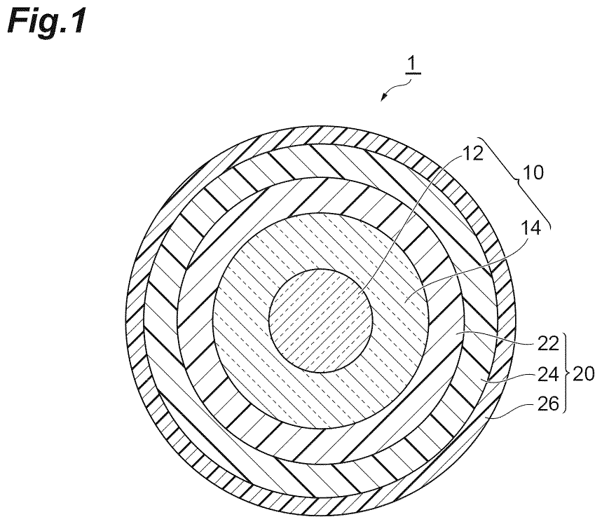

FIG. 1 is a schematic cross-sectional view showing a configuration of an optical fiber according to an embodiment. As shown in FIG. 1, an optical fiber 1 includes a glass fiber 10 and a coating resin layer 20 that is in contact with the glass fiber 10 and coats the outer periphery of the glass fiber 10. The glass fiber 10 includes a core 12 and a cladding 14. The coating resin layer 20 includes a primary resin layer 22, a secondary resin layer 24, and a colored resin layer 26.

The glass fiber 10 is a light guiding optical transmission medium that transmits light introduced into the optical fiber 1. The glass fiber 10 is a glass member, and for example, is configured by using silica (SiO₂) glass as a base material (a main component). The glass fiber 10 includes the core 12 and the cladding 14 covering the core 12. The glass fiber 10 transmits light introduced into the optical fiber 1. The core 12, for example, is provided in a region including the central axis line of the glass fiber 10. The core 12, for example, consists of pure silica (SiO₂) glass, or SiO₂ glass in which germanium dioxide (GeO₂) and/or fluorine element, and the like are contained. The cladding 14 is provided in a region surrounding the core 12. The cladding 14 has a refractive index lower than a refractive index of the core 12. The cladding 14 is made of, for example, pure SiO₂ glass or SiO₂ glass doped with a fluorine element. An outer diameter of the glass fiber 10 is, for example, about 100 μm to 125 μm, and the diameter of the core 12 forming the glass fiber 10 is, for example, about 7 μm to 15 μm.

The coating resin layer 20 is an ultraviolet curable resin layer coating the cladding 14. The coating resin layer 20 includes the primary resin layer 22 coating an outer periphery of the glass fiber 10, the secondary resin layer 24 coating an outer periphery of the primary resin layer 22, and the colored resin layer 26 coating an outer periphery of the secondary resin layer 24. The primary resin layer 22 is in contact with an outer peripheral surface of the cladding 14 and coats the entire cladding 14. The secondary resin layer 24 is in contact with the outer peripheral surface of the primary resin layer 22 and coats the entire primary resin layer 22. The colored resin layer 26 is in contact with the outer peripheral surface of the secondary resin layer 24 and coats the entire secondary resin layer 24. The thickness of the primary resin layer 22 is, for example, 10 μm or more and 50 μm or less. The thickness of the secondary resin layer 24 is, for example, 10 μm or more and 40 μm or less. The thickness of the colored resin layer 26 is, for example, 3 μm or more and 10 μm or less.

An outer diameter of the optical fiber 1 may be 255 μm or less, 220 μm or less, 180 μm or less, or 160 μm or less, and may be 140 μm or more, from the viewpoint of reducing the diameter. The outer diameter of the optical fiber 1 may be 140 μm or more and 255 μm or less, 140 μm or more and 220 μm or less, 140 μm or more and 180 μm or less, or 140 μm or more and 160 μm or less.

When the outer diameter of the glass fiber 10 is about 125 μm and the thickness of the coating resin layer 20 is 20 μm or more and 48 μm or less, the thickness of each of the primary resin layer 22 and the secondary resin layer 24 may be about 8 μm to 38 μm, and for example, the thickness of the primary resin layer 22 may be 25 μm and the thickness of the secondary resin layer 24 may be 10 μm. The outer diameter of the optical fiber 1 may be about 165 μm to 221 μm.

When the outer diameter of the glass fiber 10 is about 100 μm and the thickness of the coating resin layer 20 is 22 μm or more and 37 μm or less, the thickness of each of the primary resin layer 22 and the secondary resin layer 24 may be about 5 μm to 32 μm, and for example, the thickness of the primary resin layer 22 may be 25 μm and the thickness of the secondary resin layer 24 may be 10 μm. The outer diameter of the optical fiber 1 may be about 144 μm to 174 μm.

The primary resin layer 22 can be formed, for example, by curing a resin composition containing urethane (meth)acrylate, a monomer, and a photopolymerization initiator. For the resin composition for the primary resin layer, conventionally known techniques can be used.

The secondary resin layer 24 can be formed, for example, by curing a resin composition containing urethane (meth)acrylate, a monomer, and a photopolymerization initiator. For the resin composition for the secondary resin layer, conventionally known techniques can be used.

The colored resin layer 26 can be formed by curing the resin composition for the colored resin layer. The number of titanium-containing particle(s) having a diameter of 5 μm or more (hereinafter, also referred to as “particle(s) having a diameter of 5 μm or more”) contained in the colored resin layer 26 is less than 15 per mm in a length direction of the colored resin layer from the viewpoint of the lateral pressure resistance. From the viewpoint of further improving the lateral pressure resistance, the number of particle(s) having a diameter of 5 μm or more contained in the colored resin layer 26 may be 14 per mm or less, 13 per mm or less, 12 per mm or less, 11 per mm or less, 10 per mm or less, or 5 per mm or less in the length direction of the colored resin layer. The number of particle(s) having a diameter of 5 μm or more contained in the colored resin layer 26 may be 0 per mm in the length direction of the colored resin layer. The particle(s) having a diameter of 5 μm or more are particle(s) having a diameter of 5 μm or more (the maximum diameter in the case of a shape other than a spherical shape) when observed using an optical microscope. The particle(s) having a diameter of 5 μm or more contained in the colored resin layer 26 include aggregates and the like generated due to titanium oxide particles. The number of particle(s) having a diameter of 5 μm or more can be measured using an optical microscope, and whether or not the titanium element is contained can be determined by performing X-ray analysis.

A content of silicon (Si) in a surface of the colored resin layer 26 is 0.9 at % or more and 11 at % or less from the viewpoint of the lateral pressure resistance and the hot water resistance. at % is atomic percent. That is, the percentage of the silicon element in the elements in the surface of the colored resin layer 26 is 0.9 atomic percent or more and 11 atomic percent or less. The content of Si in the surface of the colored resin layer 26 may be 1 at % or more, 1.5 at % or more, or 2 at % or more from the viewpoint of the lateral pressure resistance, and may be 10.5 at % or less or 10 at % or less from the viewpoint of hot water resistance characteristics. The content of Si in the surface of the colored resin layer 26 may be 1 at % or more and 10.5 at % or less, 1 at % or more and 10 at % or less, 1.5 at % or more and 10 at % or less, or 2 at % or more and 10 at % or less.

### (Optical Fiber Ribbon)

An optical fiber ribbon can be produced using the optical fiber according to the embodiment. In the optical fiber ribbon, a plurality of the above-described optical fibers are arranged in parallel and coated with a resin for a ribbon.

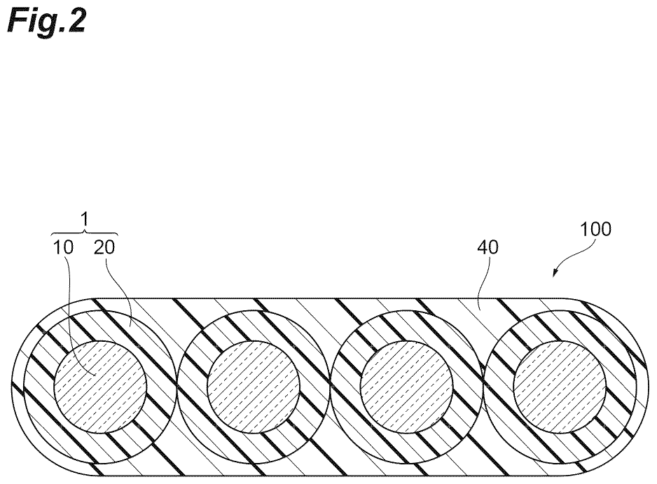

FIG. 2 is a schematic cross-sectional view showing an optical fiber ribbon according to an embodiment. An optical fiber ribbon 100 includes a plurality of optical fibers 1 and a connecting resin layer 40 in which the optical fibers 1 are coated with a resin for a ribbon and connected. In FIG. 2, as an example, four optical fibers 1 are shown, but the number of optical fibers 1 is not particularly limited.

As the resin for the ribbon, a resin material generally known as a ribbon material can be used. From the viewpoint of damage preventing property of the optical fiber, dividing easiness, and the like of the optical fiber, the resin for the ribbon may include a thermosetting resin such as a silicone resin, an epoxy resin, or a urethane resin, or an ultraviolet-curable resin such as epoxy acrylate, urethane acrylate, or polyester acrylate.

By using the optical fiber described above, the optical fiber ribbon according to the embodiment has excellent lateral pressure resistance and hot water resistance.

### EXAMPLES

The present disclosure will be described in more detail with reference to the following examples, but the present invention is not limited to the following examples.

### [Resin Composition for Colored Resin Layer]

### (Polydimethylsiloxane Compound)

Polydimethylsiloxane compounds (PDMS) shown in Table 1 were prepared. The content of Si contained in the polydimethylsiloxane compound was measured by ICP-OES according to the following procedure. First, 2 mL of hydrofluoric acid and 6 mL of nitric acid were added to 0.1 g of the polydimethylsiloxane compound, and then the temperature was raised to 200° C. over 30 minutes and held for 20 minutes using a microwave decomposition apparatus. Thereafter, the temperature was lowered to room temperature (25° C.) to obtain a decomposition liquid of the polydimethylsiloxane compound. Then, the decomposition liquid was diluted 50-fold with ultrapure water to prepare a sample. The content of Si contained in the polydimethylsiloxane compound was calculated by quantifying Si in the sample using an ICP emission spectroscopic analyzer (“iCAP6300” manufactured by Thermo Fisher Scientific Inc.).

TABLE 1

| | Organic group other | Si content |
|---|---|---|
| PDMS | than methyl group | (% by mass) |
| PDMS-1 | Acryloyl group | 10 |
| PDMS-2 | Epoxy group | 10 |
| PDMS-3 | — | 10 |
| PDMS-4 | Methacryloyl group | 10 |

### (Photopolymerizable Compound)

As photopolymerizable compounds, bisphenol A epoxy diacrylate (EA), tripropyleneglycoldiacrylate (TPGDA), EO-modified trimethylolpropane triacrylate (TMP(EO)₃TA), and EO-modified bisphenol A diacrylate (BPA(EO)₃₀DA) were prepared.

### (Photopolymerization Initiator)

As photopolymerization initiators, 2,4,6-trimethylbenzoyl diphenylphosphine oxide (Omnirad TPO) and 1-hydroxycyclohexyl phenyl ketone (Omnirad 184) were prepared.

### (Titanium Oxide Particles)

As titanium oxide particles, surface-treated titanium oxide particles including a surface-treated layer containing aluminum oxide (Al₂O₃) were prepared. The average primary particle diameter of the surface-treated titanium oxide particles was 200 to 300 nm, and the content of Al₂O₃ calculated by measurement using ICP-MS was 2.5% by mass.

After mixing the photopolymerizable compound and the photopolymerization initiator at the blending amounts (parts by mass) shown in Table 2, the surface-treated titanium oxide particles and PDMS were mixed so that the contents of the surface-treated titanium oxide particles and PDMS in the resin composition became the % by mass shown in Table 2 to prepare the resin compositions of Test Examples 1 to 10. Test Examples 1 to 8 correspond to Examples, and Test Examples 9 and 10 correspond to Comparative Examples.

### [Resin Composition for Primary Resin Layer]

Urethane acrylate oligomer obtained by reacting polypropylene glycol with a molecular weight of 4000, isophorone diisocyanate, and hydroxyethyl acrylate was prepared. 65 parts by mass of the urethane acrylate oligomer, 25 parts by mass of nonylphenol polyethylene glycol (meth)acrylate, 10 parts by mass of N-vinyl caprolactam, and 1 part by mass of 2,4,6-trimethyl benzoyl diphenyl phosphine oxide (produced by BASF, trade name “Lucirin TPO”) were mixed to prepare a resin composition P.

### [Resin Composition for Secondary Resin Layer]

40 parts by mass of urethane acrylate oligomer (UA), which was a reaction product of polypropylene glycol having a molecular weight of 600, 2,4-tolylene diisocyanate, and 2-hydroxyethyl acrylate, 35 parts by mass of isobornyl acrylate (IBOA), 24 parts by mass of epoxy acrylate (EA), which was an acrylic acid adduct of bisphenol A-diglycidyl ether, 1 part by mass of Omnirad TPO, and 1 part by mass of Omnirad 184 were mixed to prepare a resin composition S.

### [Production of Optical Fiber]

A primary resin layer having a thickness of 35 μm was formed using the resin composition P on the outer periphery of a glass fiber having a diameter of 125 μm and composed of a core and a cladding, and a secondary resin layer having a thickness of 25 μm was further formed using the resin composition S on the outer periphery thereof, thereby producing an optical fiber having a diameter of 245 μm. Next, after temporarily winding the optical fiber, and a colored resin layer having a thickness of 5 μm was formed using the resin composition of each of Test Examples 1 to 10 on the outer periphery of the secondary resin layer while feeding out the optical fiber again by a coloring machine, thereby producing an optical fiber (hereinafter, referred to as “colored optical fiber”) having a diameter of 255 μm and having the colored resin layer. The linear speed at the time of forming each resin layer was 1500 m/min.

### (Number of Particle(s) Having Diameter of 5 μm or More)

The colored optical fiber was observed from the side surface of the colored optical fiber with an optical microscope (magnification: 300 times) in a state of being immersed in the silicone oil, and the number of particle(s) having a diameter (maximum diameter when the shape is other than a spherical shape) of 5 μm or more per 1 mm in the length direction of the colored optical fiber was measured. The number of measurement regions was set to 10, and the average value was calculated. Whether the particle(s) contained titanium element was determined by performing X-ray analysis of the colored optical fiber and judging based on whether titanium element was detected.

### (Si Content in Surface of Colored Resin Layer)

The content of Si in the surface of the colored resin layer of the colored optical fiber was measured by X-ray photoelectric spectroscopy using QuanteraSXM manufactured by ULVAC PHI. The measurement was performed under the following conditions. The measurement results are shown in Table 2.
X-ray conditions: 20 μm, 4.5 W, 15 kV
Transmitted energy: narrow 55 eV, depth 112 eV
Photoelectron take-off angle: 45°
Ion gun conditions at depth: 0.5 kV, 1 kV, 2 kV, 1×1
Average sputtering rate: 1.04 nm/min

### (Lateral Pressure Resistance)

Each of a colored optical fiber and another colored optical fiber which had once been wound in a single layer around a bobbin having a diameter of 280 mm covered with sandpaper (grit size 240) was wound around a mandrel having a diameter of 40 mm, and the transmission loss of light having a wavelength of 1550 nm was measured by an optical time domain reflectometer (OTDR) method. The difference in the measured transmission losses was determined, and the lateral pressure resistance was evaluated by setting a case where the transmission loss difference was 0.5 dB/km or less as “A” and a case where the transmission loss difference was more than 0.5 dB/km as “B”

### (Hot Water Resistance)

A 1000 m bundle of the colored optical fiber was immersed for 30 days in hot water at 60° C., and then the transmission loss of light having a wavelength of 1550 nm was measured by an optical time domain reflectometer (OTDR) method. The hot water resistance was evaluated as “A” in a case where a difference between the transmission loss before immersion in hot water and the transmission loss after immersion in hot water for 30 days was 0.05 dB/km or less, and as “B” in a case where the difference was more than 0.05 dB/km.

TABLE 2

| Test Example | 1 | 2 | 3 | 4 | 5 | 6 | 7 | 8 | 9 | 10 |
|---|---|---|---|---|---|---|---|---|---|---|
| EA | 55.0 | 56.0 | 55.0 | 56.0 | 55.0 | 56.0 | 55.0 | 56.0 | 52.5 | 56.4 |
| TPGDA | 13.5 | 13.5 | 13.5 | 13.5 | 13.5 | 13.5 | 13.5 | 13.5 | 13.5 | 13.5 |
| TMP(EO)₃TA | 9.5 | 10.0 | 9.5 | 10.0 | 9.5 | 10.0 | 9.5 | 10.0 | 9.5 | 10.0 |
| BPA(EO)₃₀DA | 19.5 | 20.0 | 19.5 | 20.0 | 19.5 | 20.0 | 19.5 | 20.0 | 19.5 | 20.0 |
| Omnirad 184 | 6.0 | 6.0 | 6.0 | 6.0 | 6.0 | 6.0 | 6.0 | 6.0 | 6.0 | 6.0 |
| Omnirad TPO | 1.0 | 1.0 | 1.0 | 1.0 | 1.0 | 1.0 | 1.0 | 1.0 | 1.0 | 1.0 |
| TiO₂(% by mass) | 5.0 | 5.0 | 5.0 | 5.0 | 5.0 | 5.0 | 5.0 | 5.0 | 5.0 | 5.0 |
| PDMS-1(% by mass) | 2.5 | 0.5 | — | — | — | — | — | — | 5.0 | 0.1 |
| PDMS-2(% by mass) | — | — | 2.5 | 0.5 | — | — | — | — | — | — |
| PDMS-3(% by mass) | — | — | — | — | 2.5 | 0.5 | — | — | — | — |
| PDMS-4(% by mass) | — | — | — | — | — | — | 2.5 | 0.5 | — | — |
| Number of particle(s) | 5 | 10 | 5 | 10 | 5 | 10 | 5 | 10 | 5 | 15 |
| having diameter of 5 | | | | | | | | | | |
| μm or more | | | | | | | | | | |
| Si content (at %) | 8 | 2 | 5 | 1 | 10 | 2 | 8 | 2 | 12 | 0.8 |
| Lateral pressure | A | A | A | A | A | A | A | A | A | B |
| resistance | | | | | | | | | | |
| Hot water resistance | A | A | A | A | A | A | A | A | B | A |

### REFERENCE SIGNS LIST

1 optical fiber
10 glass fiber
12 core
14 cladding
20 coating resin layer
22 primary resin layer
24 secondary resin layer
26 colored resin layer
40 connecting resin layer
100 optical fiber ribbon

What is claimed is:

1. An optical fiber comprising:
a glass fiber including a core and a cladding;
a primary resin layer being in contact with the glass fiber and coating the glass fiber;
a secondary resin layer coating the primary resin layer; and
a colored resin layer coating the secondary resin layer,
wherein the colored resin layer includes a cured product of a resin composition containing a photopolymerizable compound, a photopolymerization initiator, a polydimethylsiloxane compound, and titanium oxide particles,
wherein a number of titanium-containing particle(s) having a diameter of 5 μm or more contained in the colored resin layer, is less than 15 per mm in a length direction of the colored resin layer, and
wherein a content of silicon in a surface of the colored resin layer is 0.9 at % or more and 11 at % or less.

2. The optical fiber according to claim 1, wherein a content of the titanium oxide particles is 0.6% by mass or more and 20.0% by mass or less with respect to a total amount of the resin composition.

3. The optical fiber according to claim 1, wherein the polydimethylsiloxane compound has at least one organic group selected from the group consisting of a (meth)acryloyl group, an epoxy group, and a polyether group.

4. The optical fiber according to claim 1, wherein a content of silicon atoms contained in the polydimethylsiloxane compound is 6% by mass or more and 40% by mass or less.

5. The optical fiber according to claim 1, wherein the optical fiber has an outer diameter of 140 μm or more and 255 μm or less.

6. An optical fiber ribbon in which a plurality of optical fibers according to claim 1 are arranged in parallel and coated with a resin for a ribbon.
